(19) United States
(12) Patent Application Publication
(10) Pub. No.: US 2004/0205477 A1
(43) Pub. Date: Oct. 14, 2004

(54) System for recording a presentation

(76) Inventor: I-Jong Lin, Woodside, CA (US)

Correspondence Address: HEWLETT-PACKARD COMPANY, Intellectual Property Administration, P.O. Box 272400, Fort Collins, CO, 80527-2400, US

(21) Appl. No.: 09/952,641

(22) Filed: Sep. 13, 2001

(51) Int. Cl. G09G 5/12; G06F 15/00; G06F 17/00; G06F 17/21; G06F 17/24

(52) U.S. Cl. 715/500.1; 345/730

(57) ABSTRACT

A system for generating a data object of a recording of a real-time slide presentation is described. The data object includes a plurality of synchronized overlaid replayable bitstreams including at least a bitstream corresponding to an image of each of a plurality of slides of the slide presentation, a bitstream corresponding to symbolic representations of presenter's interactions with points of interest within each slide, and a bitstream corresponding to a presenter's audio associated with each slide. The system generates the bitstream corresponding to the symbolic representation of the presenter's interactions from captured image data of the real-time presentation by identifying points of interest of located objects in front of the display area and assigning symbols to each point of interest. The symbolic representation bitstream is then synchronized with a corresponding audio bitstream and the slide image data of the presentation.

### FIELD OF THE INVENTION

The present invention relates to a computer controllable display system and in particular, this disclosure provides a multimedia data object representing a real-time slide presentation, a system for recording a multimedia data object, and a system and method of creating a browsable multimedia data object on a presenter interaction event-by-event basis.

### BACKGROUND OF THE INVENTION

Computer controlled projection systems generally include a computer system for generating image data in the form of a slide presentation and a projector for projecting the image data onto a projection screen. Typically, the computer controlled projection system is used to allow a presenter to project slide presentations that were created with the computer system onto a larger screen so that more than one viewer can easily see the slides. Often, the presenter interacts with the projected slide images by pointing to notable areas on the slides with his/her finger, laser pointer, or some other pointing device or instrument.

It is common that if an individual is unable to personally attend and view a slide presentation, they can instead obtain a digital copy of the slides shown at the presentation and view them at a later time on their personal computer system. In this way, they are able to at least obtain the information within the slides. However, later viewing of the slides is lacking in that the slides do not include the additional information that was imparted by the presenter during the presentation, such as the verbal annotations of each slide as well as the interaction of the presenter with each slide. Moreover, the synchronization between each verbal annotation and a corresponding presenter interaction with each slide is also lost when later viewing. For example, during a presentation a speaker may point to an area of interest within a slide while simultaneously providing a verbal annotation relating to the particular area within the slide. This type of information is lost when an individual is simply provided with a set of slides to view at a later time.

One manner to overcome the above problem is to video-tape the presentation so that the viewer can replay the videotape of the presentation and see the presenter's interaction with the slides and hear the presenter's audio description of the slides while at the same time viewing the slides. However there are several drawbacks with a video taped presentation. First, video taped presentations use a relatively large amount of storage and require a relatively large amount of bandwidth to transmit and/or download. Because of this, it can be either difficult or impossible to obtain and view a video taped presentation in situations in which storage or bandwidth is limited. Secondly, even though a video taped presentation captures all of the desired elements of the slide presentation (i.e., the slides, the presenter's interaction with the slides, and the presenter's audio) the video taped slides potentially may not be clear or readable because of resolution limitation of the video recording device or because the presentation is not recorded properly. For instance, during video taping the presenter may accidentally block the line of sight between the video camera and the slides such that the slides are not visible or clear within the video taped presentation. Another disadvantage is that it may be inconvenient to video tape the slide presentation. In addition, this technique requires an additional person to operate the video equipment. Finally, professional video taping of a presentation requires expensive or specialized production equipment.

An alternative to video taping a presentation is to simply record the presenter's audio during the presentation so that both the slides and associated audio is available to a later viewer. In one known technique, portions of the audio are associated with specific slides such that when a slide is replayed, the associated audio is also replayed. Unfortunately, this solution is lacking in that it does not provide the viewer with the presenter's interaction with the slide presentation that may impart additional information.

Hence, what is needed is a means of providing a recording of a real-time slide presentation that incorporates the information imparted by the slides, the presenter's physical interactions with the slides, and the presenter's audio contribution in a synchronous manner so as to produce a coherent replayable recording of the real-time presentation.

### SUMMARY OF THE INVENTION

A multimedia data object includes a data stream having a plurality of synchronized overlaid replayable bitstreams representing a previously captured recording of a real-time computer controlled slide presentation and a presenter's interaction with slides displayed in a computer controllable display area. The bitstreams include at least a first bitstream corresponding to each of a plurality of slides of the slide presentation, a second bitstream corresponding to a symbolic representation of each presenter interaction with a point(s) of interest within each slide during the presentation, and a third bitstream corresponding to the audio portion of the presenter during the presentation. The plurality of synchronized overlaid bitstreams are replayable using a computer system such that while each slide is replayed, the symbolic representation of the presenter's interactions are overlaid upon the slide and the audio corresponding to the slide is replayed. In one embodiment, the multimedia data object further includes a fourth bitstream corresponding to captured video clips of the real-time presentation.

One embodiment of the present invention is a system for recording the real-time slide presentation that was captured by an image capture device to provide captured image data and by an audio capture device to provide a captured audio signal. The real-time slide presentation includes a computer controlled display area for displaying a plurality of slide images having corresponding slide image data and also includes a presenter interacting with points of interest within slides displayed within the display area. The system includes a means for generating a symbolic representation bitstream corresponding to the presenter's interaction (referred to as a presenter interaction event) with the slide images displayed within the display area. The system further includes a means for synchronizing at least an audio bitstream corresponding to the captured audio signal of the real-time slide presentation, slide image data bitstream corresponding to the plurality of slide images, and the symbolic representation bitstream on, at least, a slide-by-slide basis.

### BRIEF DESCRIPTION OF THE DRAWINGS

FIG. 1A illustrates an example of a system for capturing a real-time slide presentation and for generating a multimedia data object representing the presentation;

FIG. 1B illustrates a presenter's interaction with a point of interest within the display area of a displayed slide presentation;

FIG. 1C illustrates the insertion of a symbolic representation of the presenter's interaction within the displayed slide presentation shown in FIG. 1B;

FIG. 1D shows a replayed slide of a multimedia data object including a symbolic representation of a previously recorded presenter's interaction shown in FIG. 1C;

FIG. 2 shows a first embodiment of a multimedia data object including a plurality of bitstreams;

FIG. 3 shows the synchronization of the plurality of bitstreams of a multimedia data object shown in FIG. 2;

FIG. 4 shows a second embodiment of a multimedia data object including a plurality of bitstreams corresponding to the plurality of video clips;

FIG. 5 shows the synchronization of the plurality of bitstreams of a multimedia data object shown in FIG. 4;

FIG. 6A illustrates a first embodiment of a multimedia data object unit according to the present invention;

FIG. 6B illustrates a second embodiment of a multimedia data object unit according to the present invention;

FIGS. 7A-7F illustrate process flowcharts corresponding to the functions of the performed by the elements of the multimedia data object unit shown in FIG. 6B;

FIG. 8A illustrates one embodiment of the means for separating image data shown in FIG. 6B;

FIG. 8B illustrates one embodiment of the means for identifying a point of interest as shown in FIG. 6B;

FIG. 9 illustrates a first embodiment of a system for creating a browsable multimedia data object in which the bitstreams are linked so as to make the multimedia data object browsable on a presenter interaction event-by-event basis; and

FIG. 10 illustrates a first embodiment of a method for creating and browsing a multimedia data object according to the present invention.

### DETAILED DESCRIPTION OF THE INVENTION

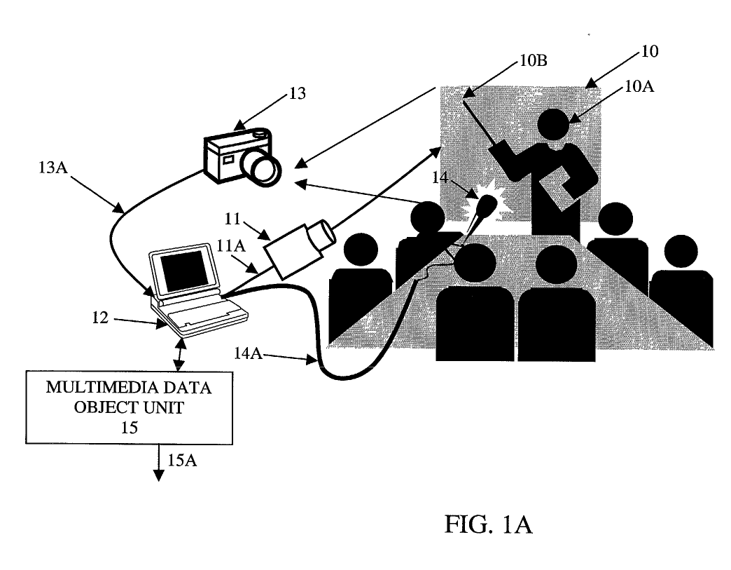

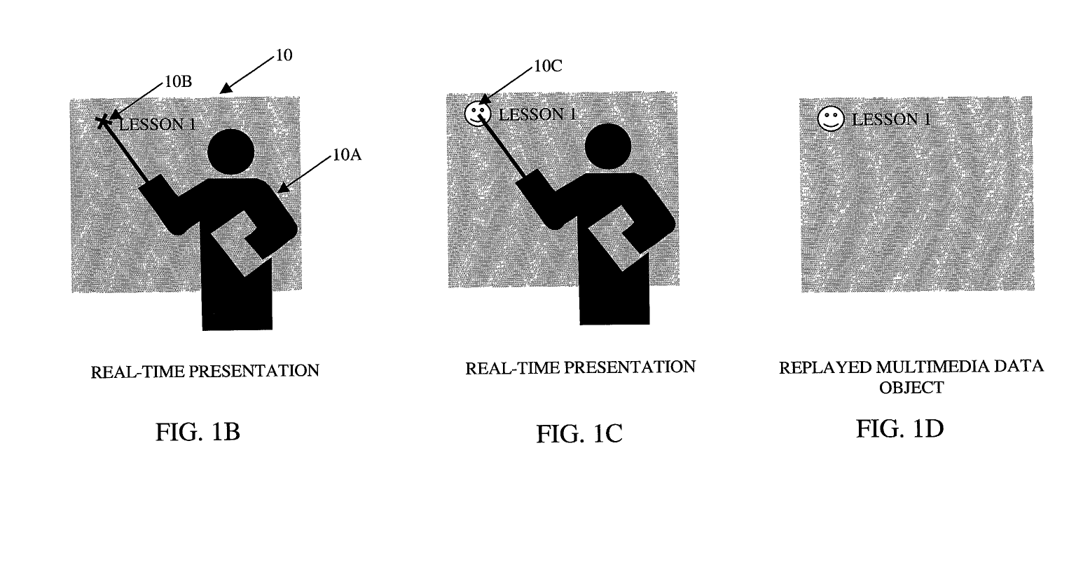

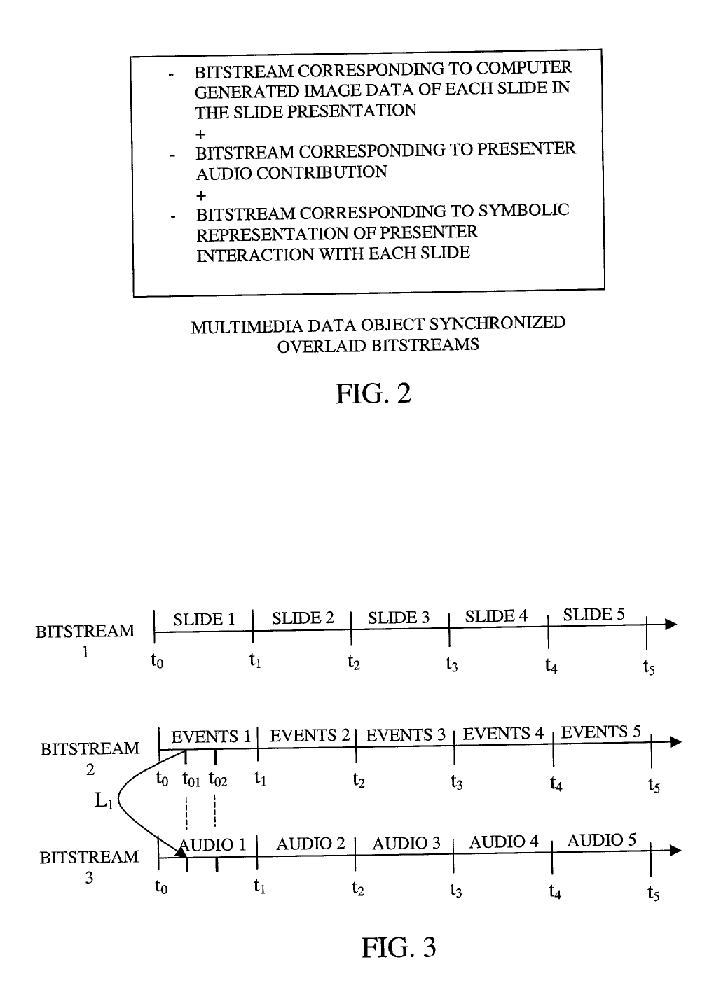

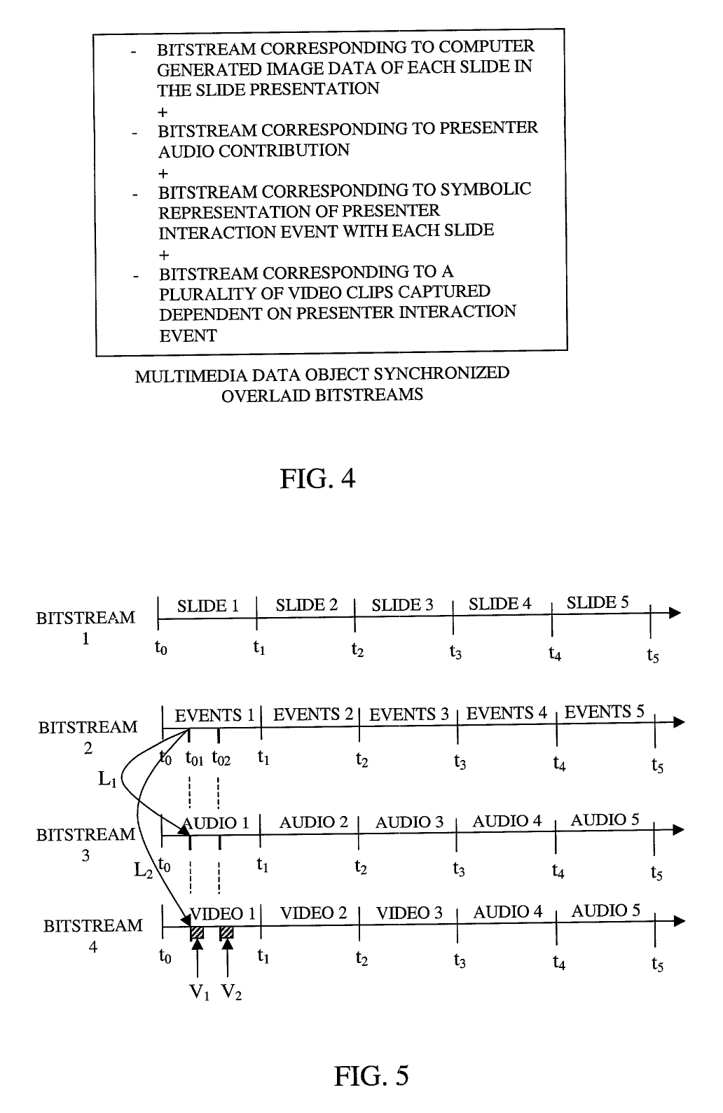

FIG. 1A shows an example of a system for capturing a real-time computer controlled slide presentation and for generating a multimedia data object representing the presentation. A display area 10 displays a plurality of slides (not shown) while a presenter 10A is positioned in front of the display area so as to present the slides. In this example, a projector 11 displays the slides. The projector is driven by an image signal 11A provided by a laptop computer 12 that represents the slides. It should be understood that other arrangements for displaying a computer controllable slide presentation are well known in the field. As each slide is shown in a generally sequential manner, the presenter 10A adds verbal annotations describing its contents while pointing at points of interest within it. For instance, the presenter may point to a bullet point within the slide and then add a verbal description of the text adjacent to the bullet point. The action or event of the presenter pointing at a point of interest within the slide is herein referred to as a presenter interaction.

During the real-time slide presentation, the multimedia data object unit 15 may function to cause a symbol to be displayed at the point of interest within the slide that the presenter interacts with during the real-time slide presentation. Specifically, as will be herein described below, multimedia data object unit 15 is 1) calibrated so as to be able to identify within captured image data the location of the display area within the image capture device capture area, 2) able to identify and locate within the captured image data objects in front of the display area including a presenter and/or an elongated pointing instrument, and 3) able to locate a point of interest of the objects in front of the display area such as the tip of the elongated pointing instrument or a point of interest corresponding to an illumination point generated by a laser pointer. As a result, the unit 15 can locate the point of interest within the image signal 11A of the corresponding slide being displayed and insert a digital symbol representing the presenter interaction with the point of interest during the real-time slide presentation. For instance, the presenter 10A can physically point at a point of interest 10B within the display area 10 (FIG. 1B) residing between the line of sight of the image capture device and the displayed slides, and a selected symbol (10C) will be displayed within the slide at that point (FIG. 1C). This predetermined symbol will be referred to herein as a symbolic representation of the presenter interaction.

Multimedia Data Object

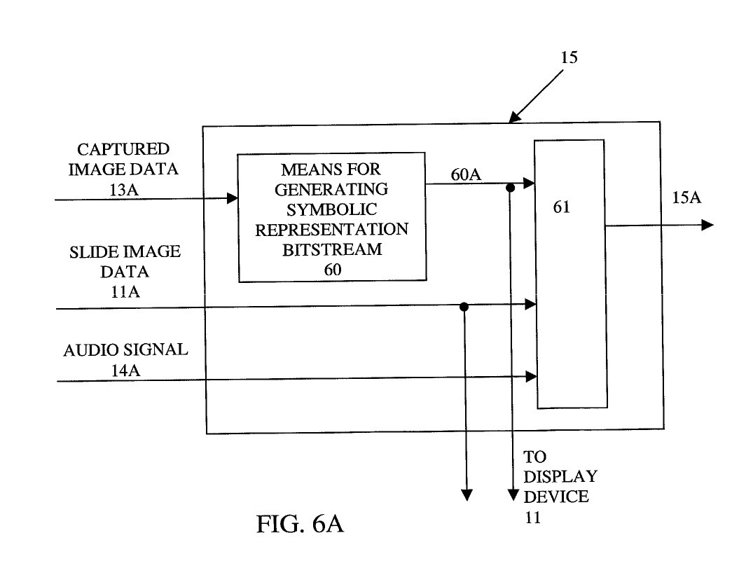

The multimedia data object unit 15 functions to generate a multimedia data object including a plurality of synchronized overlaid replayable bitstreams 15A (FIG. 1) representing the real-time slide presentation captured by image capture device 13 and audio signal capture device 14. Referring t₀₁ FIG. 2, in one embodiment the bitstreams include a first bitstream corresponding to computer generated image data 11A representing each slide in the presentation provided by the computing system 12, a second bitstream corresponding to a plurality of symbolic representations of the presenter's interactions with each slide, and a third bitstream corresponding to the presenter's audio signal 14A provided by the audio signal capture device 14.

When the plurality of bitstreams 15A are replayed by using a computer controllable display screen and an audio playback device (i.e., audio speaker), the display area displays the image of each slide according to the first bitstream having synchronously overlaid upon it the symbolic representations of the presenter's interactions corresponding to the second bitstream while the audio device synchronously replays the third audio bitstream. For example, FIG. 1D shows a replayed slide corresponding to the captured image of the real-time slide presentation shown in FIG. 1C. As shown in FIG. 1D, the image of the slide includes the image of the slide (i.e., “LESSON 1”) and the overlaid image of the symbolic representation of the presenter's interaction 10C (i.e., the smiley face). Note, that although a video image of the presenter is not shown, the presenter's interaction with the slides is still represented within the replayed slide in a low bitrate format.

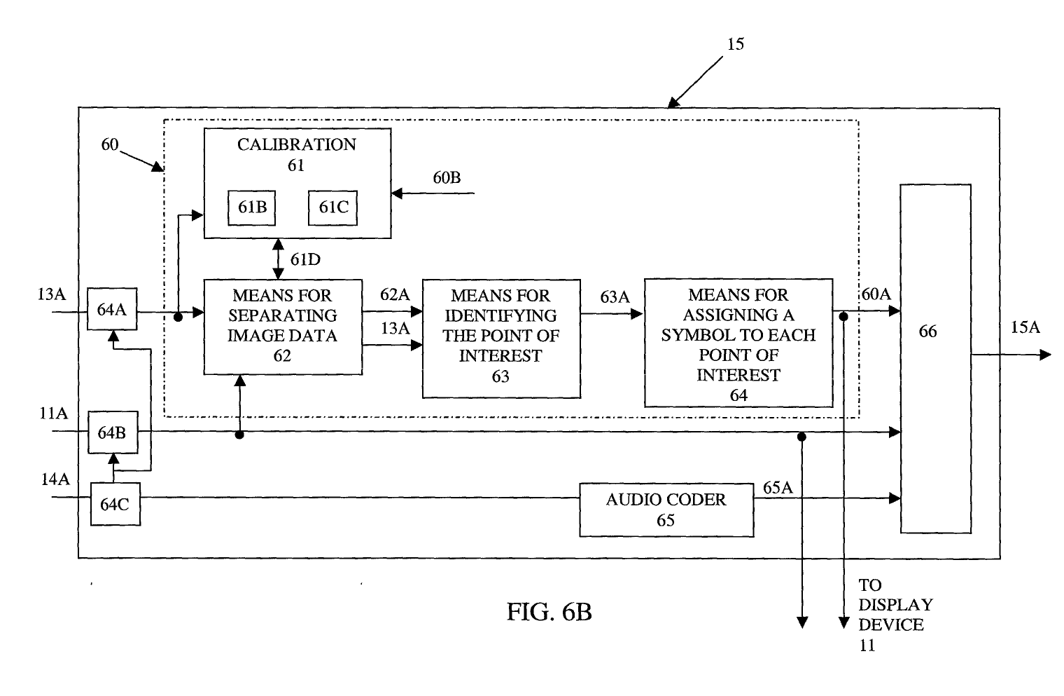

Synchronization of the overlaid replayable bitstreams is shown in FIG. 3. The bitstreams are replayable such that at beginning of the display of any given slide within bitstream 1, the corresponding symbolic representation of the presenter's interactions with the given slide within bitstream 2 is synchronously displayed and the corresponding audio track within bitstream 3 is played. For instance, at t₀ the slide 1 is displayed and the audio track, audio 1, associated with slide 1 begins to play. At t₀₁ a first presentation interaction event occurs such that a first symbolic representation of the presenter's interaction is displayed/overlaid within the slide image. Slide 1 continues to replay as does the audio track until t₀₂ wherein a second presentation interaction event occurs such that a second symbolic representation is displayed.

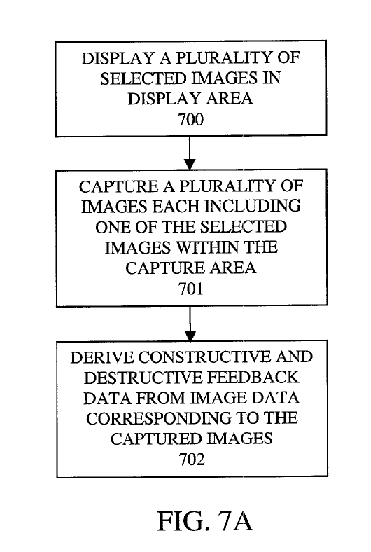

FIG. 4 shows a second embodiment of a multimedia data object 15A including a first bitstream corresponding to computer generated image data 11A representing each slide in the slide presentation provided by the computing system 12, a second bitstream corresponding to the symbolic representations of the presenter interaction with each slide, a third bitstream corresponding to the presenter's audio signal 14A, and a fourth bitstream corresponding to a plurality of video clips that were captured dependent on presenter interaction events.

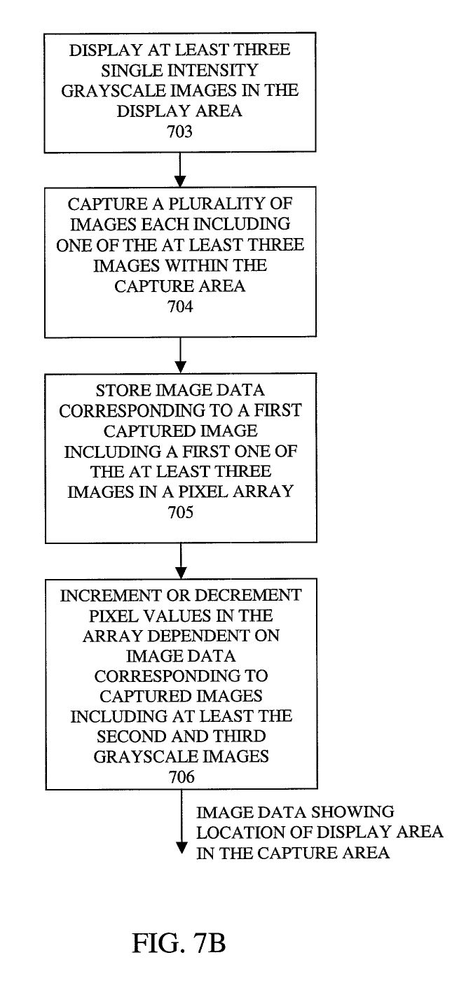

FIG. 5 shows the synchronization of the bitstreams shown in FIG. 4. As with the embodiment shown in FIG. 2, when the multimedia data object is replayed using a computer controllable display screen and an audio device, the display area replays each slide according to bitstream 1 having synchronously overlaid upon it the symbolic representations of the presenter's interaction corresponding to bitstream 2 while the audio device synchronously replays audio bitstream 3. In addition, video clips can be replayed dependent on the presenter interaction occurring within each slide, for instance, in a portion of the display screen. For instance, in one embodiment, when a symbolic representation of a presenter interaction is replayed at time t₀₁ within slide 1 (FIG. 5), the video clip V₁ associated with that presenter interaction is replayed in the corner of the display screen. Note that bitstream 4 does not comprise a continuous video recording of the presentation. Hence, in the example shown in FIG. 5, once the video clip V₁ is replayed no video image is replayed until the next presenter interaction event occurs at time t₀₂. In other words, the video clips are captured dependent on presenter interaction event. In one embodiment, the viewer may disable the viewing of the video clips by selecting an option on a user/browser interface. The advantage of recording video clips of the presentation in this manner is that it allows the viewer to see a video recording of the presenter during particular points within the real-time presentation when they are most likely to be doing something of interest while avoiding video recording the full presentation. As a result the size of the multimedia data object is minimized. Hence, the viewer is able to obtain the most information from the multimedia data object with the least amount of bandwidth consumption.

The advantage of the multimedia data objects shown in FIGS. 2 and 4 is that they represent, in one application, a new content pipeline to the Internet by 1) allowing easy production of slide presentations as content-rich multimedia data objects and 2) enabling a new representation of a slide presentation that is extremely low bit rate. The multimedia data objects enable distance learning applications over low bandwidth network structures by its compact representation of slide presentations as a document of images and audio crosslinked and synchronized without losing any relevant content of the slide presentation. Furthermore, the multimedia data objects have a naturally compressed form that is also adapted to easy browsing.

According to the present invention a multimedia data object is recorded by initially 1) capturing during the real-time slide presentation an image of the display area 10 (FIG. 1A) displaying the slides and the presenter's interactions with each slide within the display area 10 with an image capture device 13, and 2) capturing the presenter's speech using an audio signal capture device 14. The image capture device 13 and the audio signal recording device 14 provide a captured image signal 13A and the captured audio signal 14A, respectively, to the computing system 12, and more specifically to the multimedia data object unit 15.

Multimedia Data Object Unit

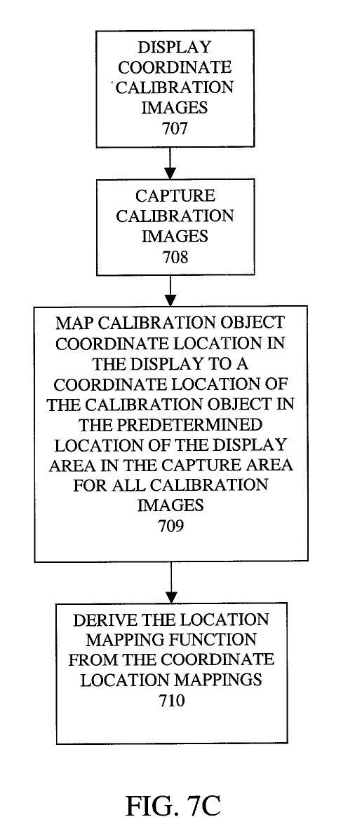

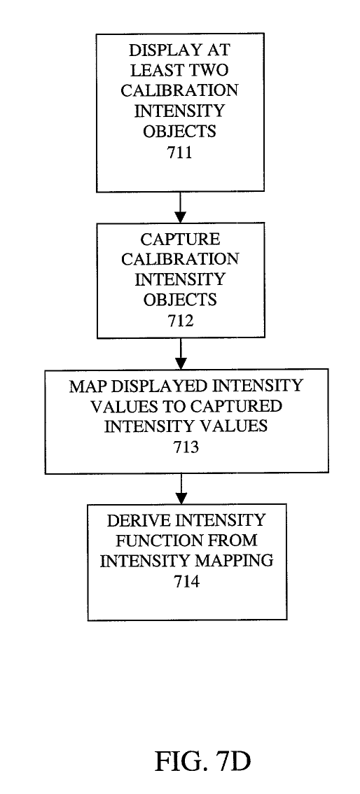

FIG. 6A shows a first embodiment of the multimedia data object unit 15 of the present invention for generating a plurality of bitstreams 15A representing a recording of a real-time slide presentation. Coupled to the unit 15 are at least three input signals corresponding to the real-time presentation including captured image data 13A, slide image data 11A, and audio signal 14A. The slide image data 11A represents computer generated image data for driving a display device so as to display a plurality of slides during the presentation. Captured image data 13A corresponds to images captured during the real-time presentation including images of the displayed slides and the presenter's interactions with the slides. Audio signal 14A corresponds to the presenter's verbal annotations during the presentation including verbal annotations associated with particular points of interest within the slides.

The captured image data 13A is coupled to the means for generating a symbolic representation bitstream 60 which corresponds to the presenter's interactions with the displayed slides during the real-time presentation. Unit 15 further includes a synchronizer that functions to synchronize the symbolic representation bitstream, the slide image data bitstream, and the audio bitstream on a slide-by-slide basis (with minimal temporal resolution) to generate signal 15A representing the real-time slide presentation.

FIG. 6B shows a second embodiment of multimedia data object unit 15 for generating a plurality of bitstreams 15A as shown in FIGS. 2 and 4. Initially (i.e., prior to the real-time presentation), block 60 is calibrated by calibration block 61 which includes a means for locating the display area within the image capture device view area (block 61B) using calibration images 60B as described in U.S. application Ser. No. 09/774,452 filed Jan. 30, 2001, entitled “A Method for Robust Determination of Visible Points of a Controllable Display within a Camera View”, and assigned to the assignee of the subject application (incorporated herein by reference) and includes a means for deriving at least one mapping function between the display area as defined by the slide image data and the captured display area as defined by the captured image data (block 61C) as described in U.S. application Ser. No. 09/775,032 filed Jan. 31, 2001, entitled “A System and Method For Robust Foreground And Background Image Data Separation For Location Of Objects In Front Of A Controllable Display Within A Camera View”, and assigned to the assignee of the subject application (incorporated herein by reference).

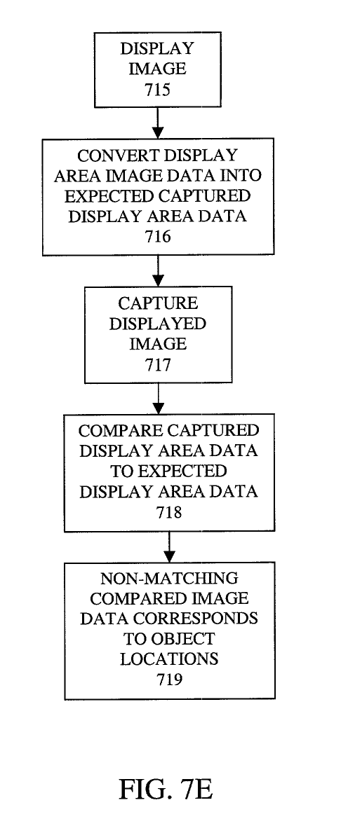

In general, block 61B locates the display area within the captured image data by causing a plurality of selected images from the calibration slide images 60B to be displayed within the display area while being captured by image capture device 13 to provide captured image data 13A including the selected calibration images. Constructive and destructive feedback data is then derived from the captured image data of the selected calibration images to determine the location of the display area. FIG. 7A shows a first functional flowchart corresponding to block 61B in which selected images are displayed (block 700), the images are captured (block 701), and constructive and destructive feedback data is derived (block 702).

FIG. 7B shows a second functional flowchart corresponding to block 61B. Referring to FIG. 7B, block 61B causes at least three single intensity grayscale images to be displayed within the display area (block 703) and the plurality of images are captured within the capture area of the image capture device each including one of the, at least three, single intensity grayscale images (block 704). Constructive or destructive feedback data is derived by block 61B storing image data corresponding to a first captured image including a first one of the, at least three, images in a pixel array (block 705) and incrementing or decrementing the pixel values dependent on the image data corresponding to the remainder of the captured images including at least the second and third single intensity grayscale images (block 706). As a result, image data showing the location of the display area within the capture area is generated. It should be understood that constructive feedback infers that a given pixel value is incremented and destructive feedback infers that a given pixel value is decremented. In one embodiment, pixel values within the array that correspond to the display area are incremented by a first predetermined constant value and pixel values within the array that correspond to the non-display area are decremented by a second predetermined constant value. In one variation of this embodiment, feedback is applied iteratively. This iterative process is achieved by block 61B causing at least second and third images to be redisplayed and again incrementing or decrementing pixel values in the array.

The means for deriving at least one mapping function (block 61C, FIG. 6B) derives, at least, a coordinate location mapping function. In general, the coordinate location mapping function is derived by displaying within the display area and capturing with the capture device a plurality of selected images from calibration images 60B—each of the selected images including a calibration object. A mapping is determined between the coordinate location of each calibration object within the computer generated slide image data and the coordination location of the same calibration object within the captured image data corresponding to the “pre-located” display area. It should be noted that the display area is “pre-located” (i.e., the location of the display area is located within the capture device view area) as described previously and shown in FIGS. 7A and 7B. FIG. 7C shows a functional flowchart corresponding to block 61C in which coordinate calibration images are displayed (block 707), the images are captured (block 708), calibration objects are mapped (block 709), and a mapping function is derived (block 710).

The pre-determination of the location of the display screen in the capture area as performed by block 61B allows for the identification of the display area within the captured image data and hence the mapping of the x-y coordinate location of a displayed calibration object to a u-v coordinate location of a captured calibration object in the predetermined display area. The individual mappings of calibration object locations then allow for the derivation of a function between the two coordinate systems:

$$( x , y ) {->}^{f} ( u , v ) \qquad Eq . 1$$

In one embodiment, a perspective transformation function (Eqs. 2 and 3) is used to derive the location mapping function:

$$\begin{matrix}{f}_{u} ( x , y ) = u = \frac{{a}_{11} x + {a}_{21} y + {a}_{31}}{{a}_{13} x + {a}_{23} y + {a}_{33}} & Eq . 2 \\ {f}_{v} ( x , y ) = v = \frac{{a}_{12} x + {a}_{22} y + {a}_{32}}{{a}_{13} x + {a}_{23} y + {a}_{33}} & Eq . 3\end{matrix}$$

The variables aᵢⱼ of Eqs. 2 and 3 are derived by determining individual location mappings for each calibration object. It should be noted that other transformation functions can be used such as a simple translational mapping function or an affine mapping function.

For instance, for a given calibration object in a calibration image displayed within the display area, its corresponding x,y coordinates are known from the slide image data 11A generated by the computer system. In addition, the u,v coordinates of the same calibration object in the captured calibration image are also known from the portion of the captured image data 13A corresponding to the predetermined location of the display area in the capture area. The known x,y,u,v coordinate values are substituted into Eqs. 2 and 3 for the given calibration object. Each of the calibration objects in the plurality of calibration images are mapped in the same manner to obtain x and y calibration mapping equations (Eq. 2 and 3).

The location mappings of each calibration object are then used to derive the coordinate location functions (Eq. 2 and 3). Specifically, the calibration mapping equations are simultaneously solved to determine coefficients a₁₁-a₃₃ of transformation functions Eqs. 2 and 3. Once determined, the coefficients are substituted into Eqs. 2 and 3 such that for any given x,y coordinate location in the display area, a corresponding u-v coordinate location can be determined. It should be noted that an inverse mapping function from u-v coordinates to x,y coordinates can also be derived from the coefficients a₁₁-a₃₃.

In one embodiment, block 61C further includes a means for deriving a mapping function of intensity as defined by the slide image data and intensity as defined according to the captured image data as described in U.S. application Ser. No. 09/775,032. The intensity mapping function is derived by displaying the calibration slide images 60B having at least two intensity calibration objects—each having different displayed intensity values. The displayed intensity values are captured to obtain captured intensity values and are then mapped to the originally displayed intensity values. The intensity mapping function is then derived from the mapping between the displayed and captured intensity values. FIG. 7D shows a functional flowchart for deriving a mapping function of intensity where at least two intensity calibration objects are displayed and captured (blocks 711 and 712), captured intensity values are mapped to known displayed intensity values (block 713), and an intensity function is derived from the mapping (block 714).

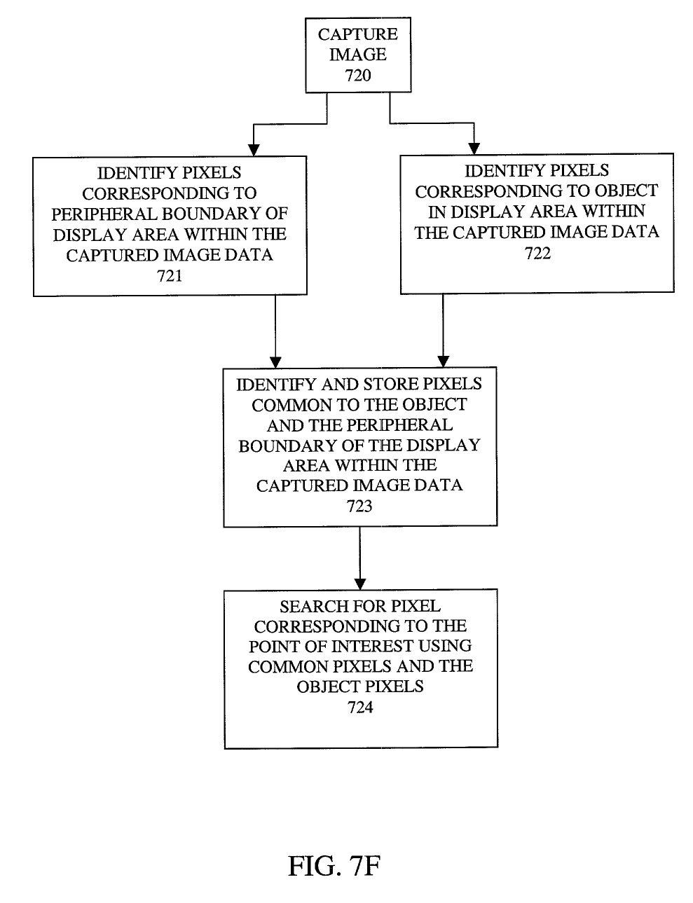

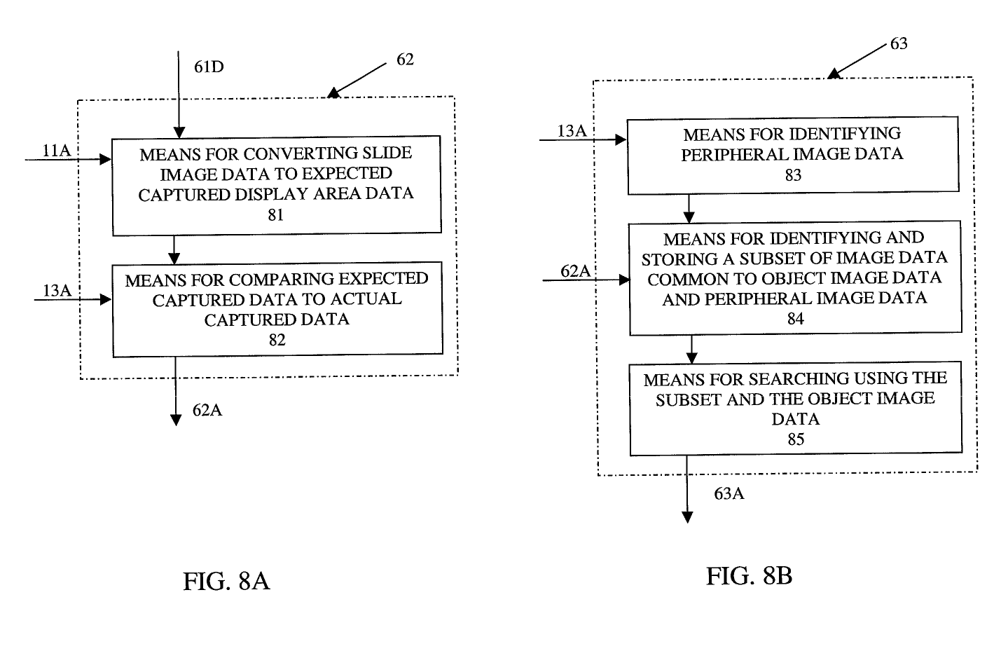

During the real-time slide presentation, the means for separating image data (block 62, FIG. 6B) separates image data corresponding to objects located within the foreground of the display area 10, for instance, a presenter and/or a pointer as described in U.S. application Ser. No. 09/775,032. More particularly, block 62 functions to identify objects residing between the line of sight of the capture device 13 (FIG. 1) and the display area 10 and extract image data 62A corresponding to the object from the captured image signal 13A. FIG. 7E shows a functional flowchart corresponding to block 62 and FIG. 8A shows one embodiment of block 62. Referring to FIG. 8A, block 62 includes a means for converting (block 81) that receives and converts slide image data 11A into expected captured display area data using transforms provided by calibration block 61 on interconnect 61D. Block 62 further includes a means for comparing (block 82) the expected captured display area data to actual captured display area data to generate object data 62A. Referring to the functional flowchart FIG. 7E, an image is displayed and captured (blocks 715 and 717), the displayed image is converted into expected captured data (block 716), the expected data is compared to actual data (block 718), and non-matching data is identified as object locations (block 719).

In accordance with block 62, captured display area data can be compared to expected display area data by subtracting the expected captured display area data (expected data) from the captured display area data (actual data) to obtain a difference value:

δ(uᵢ, vᵢ)=∥ExpectedData(uᵢ, vᵢ)−ActualData(uᵢ, vᵢ)∥ Eq. 4

where (uᵢ, vᵢ) are the coordinate locations in the capture display area. In one embodiment, the difference value δ(uᵢ, vᵢ) is then compared to a threshold value, cₜₕᵣₑₛₕ, where cₜₕᵣₑₛₕ is a constant determined by the lighting conditions, image that is displayed, and camera quality. If the difference value is greater than the threshold value (i.e., δ(uᵢ, vᵢ)>cₜₕᵣₑₛₕ) then an object exists at that coordinate point. In other words, the points on the display that do not meet the computer's intensity expected value at a given display area location have an object in the line of sight between the camera and the display.

The means for identifying a point of interest (block 63, FIG. 6B) identifies the location 10B (FIG. 1B) of the point of interest within the slide that the presenter points to with their finger or with any elongated pointing object such as a wooden pointing stick during the real-time slide presentation as described in U.S. application Ser. No. 09/775,394 filed Jan. 31, 2001, entitled “System and Method for Extracting a Point of Interest of an Object in Front of a Computer Controllable Display Captured by an Imaging Device”, and assigned to the assignee of the subject application (incorporated herein by reference). More particularly, block 63 identifies image data 63A within the separated image data 62A that corresponds to the general location of where the presenter interacted within a given slide. FIG. 7F shows a functional flowchart corresponding to block 63 and FIG. 8B shows one embodiment of block 63. Referring to FIG. 8B, block 63 includes a means for identifying (block 83) peripheral image data within image data 13A corresponding to the peripheral boundary of the display area. Block 84 identifies and stores a subset of data corresponding to pixel values common to both of the object image data 62A and the peripheral image data. The means for searching (block 85) then searches for points of interest using the subset of data and the object data. Referring the flowchart shown in FIG. 7F, the peripheral boundary is identified (block 721) while the object data is identified (block 722), a subset of data common to both the object data and the peripheral boundary data is identified (block 723), and points of interest are searched for using the subset of image data and the object data (block 724). In one embodiment, block 63 searches using a breadth-first search.

In the case in which a laser pointer is used to point to points of interest within the slides that are displayed in the display area during the real-time presentation, the point of interest is located by detecting the laser point projected on the slide, captured within the image capture data 13A. Detection of captured pixel values corresponding to a projected laser point within captured image data 13A is well know in the field and is primarily based upon analyzing/filtering the captured image data to detect pixel values having an intensity characteristic of a projected laser point. Pixel data corresponding to a projected laser point is easily discriminated because it consists generally of a single high intensity component—unlike pixel values corresponding to typical images captured during a real-time presentation. Filtering for pixel values corresponding to the laser pointer can be achieved by filtering out all single component pixel values above a given intensity threshold value.

Each of the identified points of interest within data 63A is then associated with a symbol by the means for assigning a symbol to each point of interest (block 64). Specifically, at each location corresponding to a point of interest within data 63A a symbol is inserted by block 64 to generate a bitstream 60A corresponding to the symbolic representation of each of the presenter's interactions. The type of symbol that is inserted can be pre-selected by the presenter prior to the real-time presentation or can be automatically assigned by unit 15. Note that bitstream 60A is transmitted along with the slide image data 11A to the display device 11 during the real-time presentation, so that the symbolic representation is displayed at the location of the current point of interest within the slide such as shown in FIG. 1C.

In one embodiment, the captured image data 13A and the slide image data 11A are intermittently time-stamped (blocks 64A-64C) according to the duration of the audio signal 14A. The audio signal is then converted into a digital signal by audio coder 65 to generate audio bitstream 65A.

The bitstream 60A corresponding to the symbolic representation of each of the presenter's interactions, the bitstream 11A corresponding to the slide image data, and the bitstream 65A corresponding to the audio signal are coupled to synchronization block 66 and are synchronized according to the time-stamp generated in blocks 64A-64C. Specifically, time-stamps created within each of the received signals 13A, 14A, 11A are retained with the corresponding bitstreams 60A, 11A, and 65A, respectively. The slide image data bitstream 11A and the symbolic representation bitstream 60A are synchronized to audio bitstream 64A dependent on the duration of the recorded audio signal as indicated by the time-stamps. This is in contrast to common synchronization techniques in which a separate system clock is used for synchronizing all of the signals. The advantage of synchronizing with respect to the audio bitstream instead of the system clock is that 1) a separate clock is not required for timing; 2) the audio signal represents an accurate timing of the duration of the presentation; 3) the system clock is not as accurate a timing tool of the presentation as the audio bitstream since it can become involved with other tasks and not reflect actual presentation duration time. As a result, synchronizing according to audio signal duration provides more robust presentation timing.

Bitstream Linking and Browsing

In one embodiment, the bitstreams are linked so as to make the multimedia data object browsable using a browsing interface so as to allow selection and viewing of individual slides within the slide presentation such that when a given slide is selected, each of bitstreams of the multimedia data object between the interval defining the given slide are played. Hence, the multimedia data object is browsable on a slide-by-slide basis.

In another embodiment, the bitstreams are linked so as to make the multimedia data object browsable on a presenter interaction event-by-event basis. In particular, the plurality of bitstreams further include a linking mechanism (represented by L₁ and L₂, FIGS. 3 and 5) such that when a user replays the multimedia data object and the location of a symbolic representation of a presenter's interaction is selected within a replayed slide, a portion of another bitstream that was captured at the same time that the presenter's interaction occurred during the real-time presentation is also replayed. For instance, referring to FIG. 3, if a viewer selects the location corresponding to a symbolic representation within a redisplayed slide occurring at t₀₁ within displayed slide 1, audio 1 of bitstream 3 also begins playing at time t₀₁ due to linking mechanism

In another embodiment, the symbolic interaction bitstream is linked to the multimedia data object video clip bitstream (FIG. 4) including a plurality of video clips captured during the real-time presentation. The video clips are captured in response to detected presenter interactions occurring while capturing the real-time presentation such that each of the plurality of video clips is associated with a presenter interaction that occurred during the capture of the real-time presentation. In this embodiment, the symbolic interaction bitstream is linked to a video clip bitstream such that when a slide is replayed within the multimedia data object and the location of a symbolic interaction event is selected within the slide, the video clip that was captured at the same time that the interaction event occurred during the real-time presentation is also replayed. For example, the presentation interaction event occurring at time t₀₁ is linked to video clip V1 by linking mechanism L2 such that when the presentation interaction is replayed, the video clip is synchronously replayed. It should be further noted that each presentation interaction event can be linked to more than one of the plurality of bitstreams of the multimedia data object.

The linking mechanism can be embodied as a look-up table of pointers where an interaction event pointer can be used to access the table to obtain a point to the tracked location within the other bitstream.

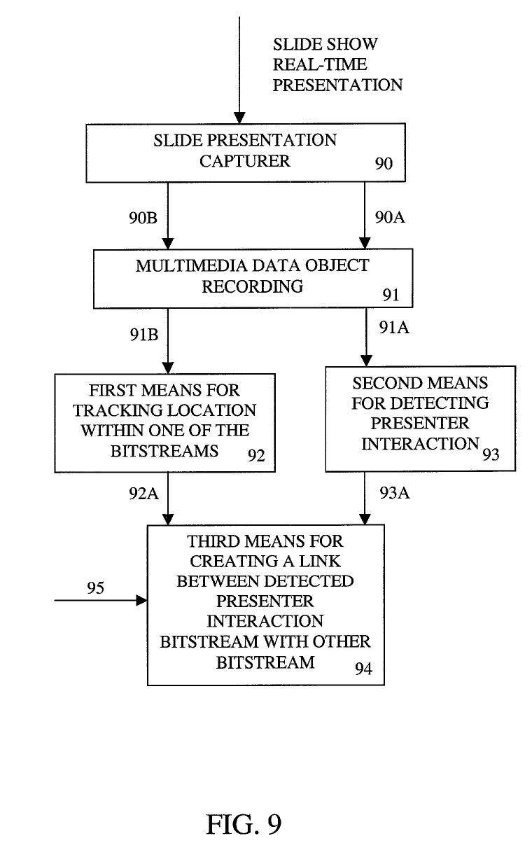

FIG. 9 shows one embodiment of a system for generating a multimedia data object in which the bitstreams are linked so as to make the multimedia data object browsable on a presenter interaction event-by-event basis. According to the system a real-time slide presentation is captured by a slide presentation capturer (block 90) so as to obtain an image signal 90A corresponding to the displayed slides and the presenter in front of the displayed slides and an audio signal 90B corresponding to the presenter's speech. The image signal 90A is coupled to a multimedia data object recorder (block 91) that functions to generate the plurality of bitstreams representing the real-time slide presentation. One of the bitstreams 91B is coupled to a first means for tracking location (block 92) within the bitstream. The bitstream corresponding to the symbolic representation of the presenter interaction 91A is coupled to a second means for detecting a presenter interaction within a slide (block 93) so as to detect the occurrence of a presenter interaction event during the presentation. Bitstream tracking information 92A and presenter interaction event information 93A is coupled to a third means for linking each detected presenter interaction with a corresponding tracked location within the audio bitstream (block 94). In one embodiment, the bitstream can be tracked using a counter such that the occurrence of an interaction event is linked to a specific time within the bitstream. Alternatively, the bitstream location can be tracked by tracking the amount of data stored such that the occurrence of the interaction event is linked to a specific location within a data file storing the bitstream. In one embodiment, the event is linked to the tracked location within the bitstream using a lookup table or index such that when the event bitstream is replayed and an interaction event is selected the location of the event is used to point to a look-up table storing tracked locations within the tracked bitstream to determine where to begin replaying the bitstream. It should be understood that in one embodiment blocks 92-94 can be embodied within the multimedia data object recorder 91 wherein event detection and bitstream tracking occurs while generating the multimedia data object.

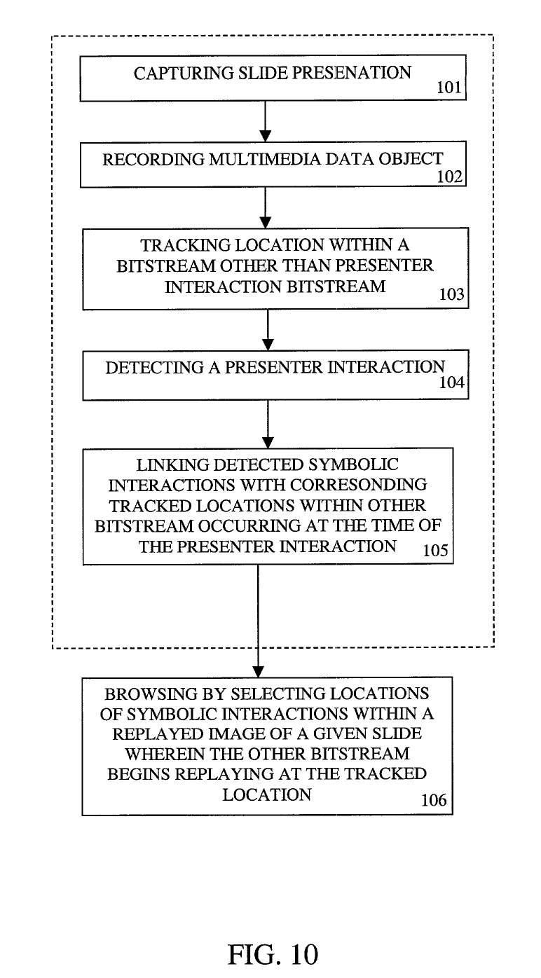

FIG. 10 shows a method for recording a multimedia data object and for browsing the multimedia data object on a presenter interaction event-by-event basis. Initially, the real-time presentation is captured so as to obtain an image signal and an audio signal (block 101) representing the presentation. A multimedia data object is generated (block 102) including a plurality of bitstreams where at least one of the bitstreams corresponds to the symbolic representation of the presenter's interaction. The location of the one of the plurality of bitstreams other than the interaction bitstream is tracked (block 103). In addition, presenter interactions within the interaction bitstream are detected (block 104). In response to a detected interaction, the corresponding tracked location within the other bitstream is linked with the symbolic representation of the detected interaction (block 105). Upon browsing of the multimedia data object and selecting (block 106) a location of the symbolic representation of the detected interaction within a redisplayed slide, the other bitstream begins replaying at the tracked location within the audio bitstream.

In the preceding description, numerous specific details are set forth in order to provide a thorough understanding of the present invention. It will be apparent, however, to one skilled in the art that these specific details need not be employed to practice the present invention. In other instances, well-known techniques have not been described in detail in order to avoid unnecessarily obscuring the present invention.

In addition, although elements of the present invention have been described in conjunction with certain embodiments, it is appreciated that the invention can be implement in a variety of other ways. Consequently, it is to be understood that the particular embodiments shown and described by way of illustration is in no way intended to be considered limiting. Reference to the details of these embodiments is not intended to limit the scope of the claims which themselves recited only those features regarded as essential to the invention.

I claim:

1. A system for recording a real-time slide presentation captured by an image capture device to provide captured image data and an audio capture device to provide a captured audio signal, the slide presentation including a computer controlled display area for displaying a plurality of slide images and including a presenter interacting with the display area, the system comprising:
means for generating a symbolic representation bitstream corresponding to presenter interaction events with the slide images displayed within the display area during the real-time slide presentation;
means for synchronizing at least the symbolic representation bitstream, an audio bitstream corresponding to the captured audio signal of the real-time slide presentation; and a slide image data bitstream corresponding to the plurality of slide images on at least a slide-by-slide basis.

2. The system as described in claim 1 wherein the means for generating further comprises a means for identifying display area image data corresponding to a computer controlled display area within captured image data including the display area using constructive and destructive image data feedback.

3. The system as described in claim 2 wherein the means for generating further comprise a means for deriving at least one transform including a location coordinate transform dependent on the display area image data and using a plurality of selected calibration slides.

4. The system as described in claim 3 wherein the means for generating further comprising a means for separating image data including:
a means for converting the display area image data to expected display area image data using at least the location coordinate transform; and
a means for comparing the expected display area image data to actual displayed slide image data wherein the difference of the comparison provides object image data corresponding to at least one object positioned in front of the display area.

5. The system as described in claim 4 wherein the means for generating further comprises a means for identifying a point of interest within the object image data including:
a means for identifying peripheral image data corresponding to the peripheral boundary of the display area within the captured image data;
a means for identifying and storing a subset of image data common to the object image data and the peripheral image data; and
a means for searching using the common sub-set and the object image data to obtain the point of interest data within the object image data.

6. The system as described in claim 5 wherein the means for generating further comprises a means for assigning a symbol to each point of interest within the point of interest data to generate the symbolic representation bitstream.

7. The system as described in claim 3 wherein the means for generating further comprises a means for identifying a point of interest within the captured image data including a means for detecting a laser point projected in the display area within the captured image data to obtain point of interest data within the captured image data.

8. The system as described in claim 7 wherein the means for generating further comprises a means for assigning a symbol to each point of interest within the point of interest data to generate the symbolic representation bitstream.

9. The system as described in claim 1 wherein the means for synchronizing further includes means for time-stamping at least the audio signal, the slide image data bitstream, and the captured image data wherein the symbolic representation bitstream, the audio bitstream and the slide image data bitstream are synchronized according to the time-stamping.

10. The system as described in claim 9 wherein the time-stamping means time-stamps at least the captured image data and the slide image data bitstream so as to synchronize the symbolic representation bitstream and the slide image data bitstream with the audio bitstream.

11. The system as described in claim 6 wherein the means for synchronizing further includes means for time-stamping at least the audio signal, the slide image data bitstream, and the captured image data wherein the symbolic representation bitstream, the audio bitstream and the slide image data bitstream are synchronized according to the time-stamping.

12. The system as described in claim 11 wherein the time-stamping means time-stamps at least the captured image data and the slide image data bitstream so as to synchronize the symbolic representation bitstream and the slide image data bitstream with the audio.

13. The system as described in claim 6 wherein the symbol is displayed during the real-time presentation at each point of interest within the displayed slides.
